(19) United States
(12) Patent Application Publication
(10) Pub. No.: US 2022/0048243 A1
(43) Pub. Date: Feb. 17, 2022

(54) Identifying Subsurface Porocity In Situ During Laser Based Additive Manufacturing Using Thermal Imaging

(71) Applicant: UCHICAGO ARGONNE, LLC, Chicago, IL (US)

(72) Inventors: Benjamin J. Gould, Chicago, IL (US); Aaron C. Greco, Chicago, IL (US); Sarah J. Wolff, Chicago, IL (US)

(21) Appl. No.: 16/992,496

(22) Filed: Aug. 13, 2020

(51) Int. Cl. B29C 64/153; B29C 64/268; B29C 64/245; B29C 64/393; B29C 64/188

(52) U.S. Cl. CPC B29C 64/153; B29C 64/268; B33Y 10/00; B29C 64/393; B29C 64/188; B29C 64/245

(57) ABSTRACT

A method for performing sub-surface porosity detection in an additively manufactured part. The method includes providing, by a laser radiation source, a first radiation to a region of a powder bed along a beam of the first radiation, the region of the powder bed being part of a corresponding region of an additively manufactured part. Infrared imaging of the region of the powder bed is performed while the first radiation is being provided to the powder bed. A processor generates data sets indicative of the temperature of the region of the powder bed; and the processor further detects, from the data sets, a defect signature indicative of the formation and/or presence of a sub-surface defect in the region of the additively manufactured part.

### STATEMENT REGARDING FEDERALLY SPONSORED RESEARCH OR DEVELOPMENT

This invention was made with government support under Contract No. DE-AC02-06CH11357 awarded by the United States Department of Energy to UChicago Argonne, LLC, operator of Argonne National Laboratory. The government has certain rights in the invention.

### FIELD OF THE DISCLOSURE

The present disclosure relates to methods and systems for performing metal additive manufacturing, and specifically, to actively detecting the formation of subsurface defects during metal additive manufacturing printing.

### BACKGROUND

The use of, and interest in, metal additive manufacturing (AM), a form of 3D printing, has seen widespread growth over the past decades across many industries including the aerospace, automotive, medical, defense and energy fields. AM techniques provide increased design flexibility compared to other manufacturing techniques, which simplifies optimizations of parts. AM techniques also increase the efficiencies of component re-design processes. For example, components such as fuel nozzles can be redesigned using new materials or geometries to be optimized to reduce fluid drag, or components such as gears or engine blocks can be made lightweight via the incorporation of honeycomb structures in non-critical locations.

Multiple techniques for metal AM currently exist, with the most common techniques (e.g., laser powder bed fusion and directed energy deposition) typically requiring the use of a laser to locally melt and re-solidify powders, resulting in a three-dimensional build. The use of high powered lasers in metal AM applications results in significant thermal gradients and numerous dynamic phenomena occurring simultaneously. Some such phenomena may include melting and vaporization of metal, powder motion, melt pool dynamics, and rapid cooling. Controlling the numerous dynamic phenomena during metal AM is extremely difficult. Consequently, parts manufactured via metal AM often contain unfavorable microstructures and defects such as pores, voids, and cracks. The voids and pores can result in porosities that can result in nucleation sites causing part failure or breaking. Because of the part porosities and the risk of part failure, parts manufactured via metal AM are often limited to non-critical, non-load-bearing components.

Methods for preventing porosity formation during AM fabrication of parts are expensive and time consuming. Currently, an Edisonian approach is commonly implemented for the optimization of a metal AM fabrication cycle for a given part. This approach includes printing multiple parts are under a variety of printing conditions. The printed parts are sectioned and the quality of each part is determined to identify optimal fabrication parameters and conditions for a given part. Further, AM parts that include complex geometries, atypical AM materials, or novel materials, often have printing conditions that are required to be varied during a fabrication cycle, and/or between fabrication cycles to minimize print defects. The added fabrication run complexity and tuning of parameters increases the probability for a part to have a defect or a pore, resulting in higher cost and longer times for part production.

Currently, no method exists for detecting defects as they form during metal AM fabrication. Therefore, many parts manufactured via metal AM require tedious and costly post print examination such as sectioning, thermal imaging, X-ray analysis, and tomography of every part produced. Post print examinations are expensive, increase production time for a part, and each examination technique is limited in the range of part sizes and pore sizes that the specific technique can examine and detect. As a result, the broad implementation of metal AM parts is currently limited by the inability to detect and mitigate the formation of defects in parts, such as pores, as they occur during fabrication.

### SUMMARY OF THE DISCLOSURE

A method for performing sub-surface porosity detection in an additively manufactured part includes providing, by a laser radiation source, a first radiation to a region of a powder bed along a beam of the first radiation. The region of the powder bed is part of a corresponding region of an additively manufactured part. The method further includes imaging the region of the powder bed while the first radiation is being provided to the powder bed and generating data sets indicative of the temperature of the region of the powder bed. A processor then process the temperature data sets and detects, from the data sets, a defect signature indicative of the presence of a sub-surface defect in the region of the additively manufactured part.

### BRIEF DESCRIPTION OF THE DRAWINGS

FIG. 1A illustrates an embodiment of an additive manufacturing system (AM) for fabricating pieces and identifying thermal defect signatures of subsurface print defects in real time.

FIG. 1B illustrates an embodiment of an additive manufacturing system (AM) for fabricating pieces and detecting subsurface print defects in real time.

FIG. 2 is a flow diagram of an embodiment of a method for identifying thermal signatures of a subsurface defect formation during an AM fabrication cycle.

FIG. 3 is a flow diagram of an embodiment of a method for using thermal signatures to detect the formation of subsurface defects during an AM fabrication cycle.

FIG. 4 is a flow diagram of an embodiment of a method for determining if a subsurface defect in a piece is a critical subsurface defect, and in response, determining whether or not to abort the fabrication of the piece.

FIG. 5A is a side view X-ray image of a melt pool of a powder bed during the application of radiation to the powder bed.

FIG. 5B is a top-down view infrared image of a melt pool of a powder bed during the application of radiation to the powder bed.

FIG. 6A is a plot of temperature versus time data representative of the thermal history for a region of a powder bed exhibiting no formation or presence of a subsurface defect.

FIG. 6B is a plot of temperature versus time data representative of the thermal history for a region of a powder bed that has formed a subsurface defect.

FIG. 7A is a side view X-ray image of a powder bed that includes the formation or presence of a subsurface defect during the application of radiation to the powder bed.

FIG. 7B is a top-down view infrared image of a powder bed including a pixel region over a subsurface defect within the powder bed.

FIG. 7C is a plot of temperature versus time data representative of the thermal history for the pixel region of the infrared image of FIG. 7B.

FIG. 7D is a plot of temperature versus time data for a pixel region of a powder bed of FIG. 7B that does not include a subsurface defect.

FIG. 8A is a side view X-ray image of a powder bed that includes the formation of a subsurface defect during the application of radiation to the powder bed.

FIG. 8B is a top-down view infrared image of a powder bed including a pixel region over a subsurface defect within the powder bed.

FIG. 8C is a plot of temperature versus time data representative of the thermal history for the pixel region of the infrared image of FIG. 8B.

FIG. 8D is a plot of temperature versus time data for a pixel region of the powder bed of FIG. 8B that does not include a subsurface defect.

### DETAILED DESCRIPTION

The identification and detection of subsurface print defects during metal additive manufacturing (AM) fabrication is essential for producing reliable AM parts. Currently, parts manufactured via metal AM are limited to non-critical and non-load-bearing components due to the possibility of subsurface defects in the parts that may result in part failure. Further, post print examinations and reprints increase the time and expense of metal AM fabrication considerably, preventing many industries from utilizing AM fabrication and AM fabricated parts. The described systems and methods enable the detection, and correction, of subsurface print defects in real-time during metal AM fabrication. The methods include using thermal signatures of defects to identify the formation and/or presence of a subsurface defect during the AM fabrication. The thermal signatures are identified by performing simultaneous X-ray and infrared imaging of a part during metal AM fabrication of the part. The X-ray imaging provides a visual side view image of the part wherein a subsurface defect may be identified. Thermal signatures may then be determined for the region of the part where the subsurface defect has formed. The determined thermal signatures may then be detected by performing infrared imaging during subsequent metal AM fabrication runs without the need for performing additional X-ray imaging.

The systems and methods described remove the need for performing post print examinations, which greatly reduces the cost and the fabrication time for producing metal AM parts. Additionally, the probability of part failure is reduced which allows for metal AM parts to be implemented in critical, high stress, and/or load bearing components. Further, the detection of subsurface defects in real-time during fabrication allows an operator of an AM system to correct the defect, or stop a print once the defect is detected, saving time and resources.

The disclosed systems and methods enable the detection of the formation and/or presence of subsurface defects and printing porosity in-situ based on the thermal history of solidified components during metal AM fabrication. An infra-red camera is used to detect anomalies in the thermal history (e.g., the surface cooling rate, shape of cooling curve, etc.) of a material as it solidifies to identify subsurface print defects (e.g., a subsurface vapor pore commonly known as a “keyhole pore”). The inventors have determined that the surface of a part directly above a keyhole pore will typically cool at a slower rate as compared to non-porous regions of a part, and that these cooling patterns can be identified through the thermal images (e.g., infrared images) and thermal history of a surface of the part. Additionally, the surface of a part above a pore may also increase in temperature after solidification, which is also not typically exhibited by non-porous regions of a part. While most additive manufacturing and laser powder bed fusion machines do not provide a means for thermal imaging of the powder bed, some commercially available AM systems include an infrared (IR) camera or offer an IR camera as an add-on option, and therefore, the identification of keyhole pores, using the methods described herein, may be performed on currently available commercial metal AM systems if the thermal imaging requirements are met or exceeded. Typically, any commercial AM system that includes an IR camera has a frame rate limited to between 1 to 100 frames per second, whereas the systems and methods described are capable of capturing at least 1000 frames per second, and preferably more than 10,000, more than 25,000, more than 50,000, or more than 100,000 frames per second. The example IR imaging measurements included, and described further herein, are performed at frame rates of between 10,000 and 20,000 frames per second, which is at least two orders of magnitude greater than commercially available systems. Further, most commercial AM systems with the capability of thermal imaging typically only provide relative temperature measurements rather than absolute temperature measurements.

As well as improving the metal AM print quality, the described systems and methods also reduce the time and complexity of rapid optimization of printing parameters for new print geometries and/or materials. Typically, determining print parameters for new materials requires performing multiple metal AM laser scans with different laser parameters (e.g., powers, velocities, hatch spacing etc.) on the material before an actual part is printed. For novel or difficult print geometries, potential problem areas (e.g., laser turn around points, corners, etc.) are typically repeated under various laser conditions to determine the laser parameters that result in the fewest defects. These print parameter optimizations result in long setup and configuration times for the production of new parts or the use of new materials. The ability to determine subsurface defect formation during print parameter optimization laser scans can enable real-time tuning of print parameters which can reduce the amount of time and materials required for performing print parameter optimization of a material.

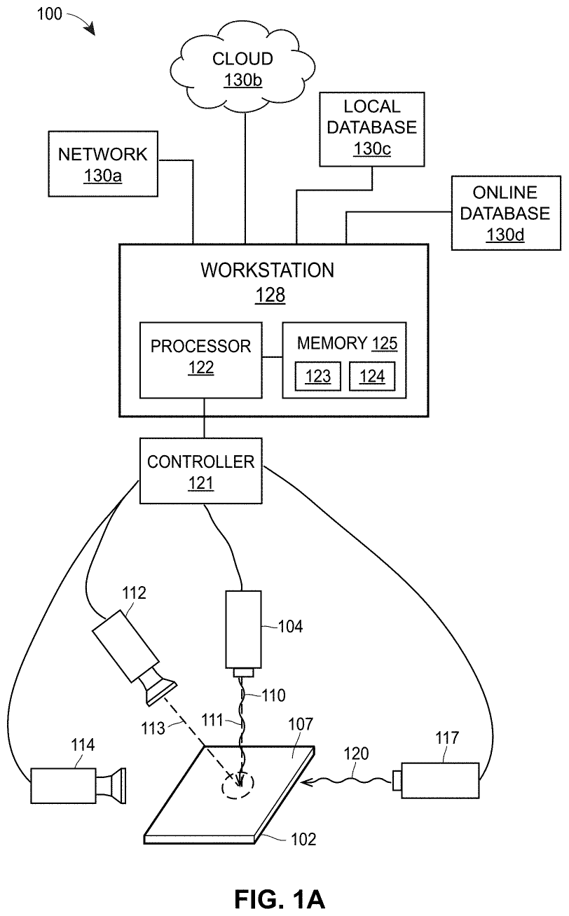

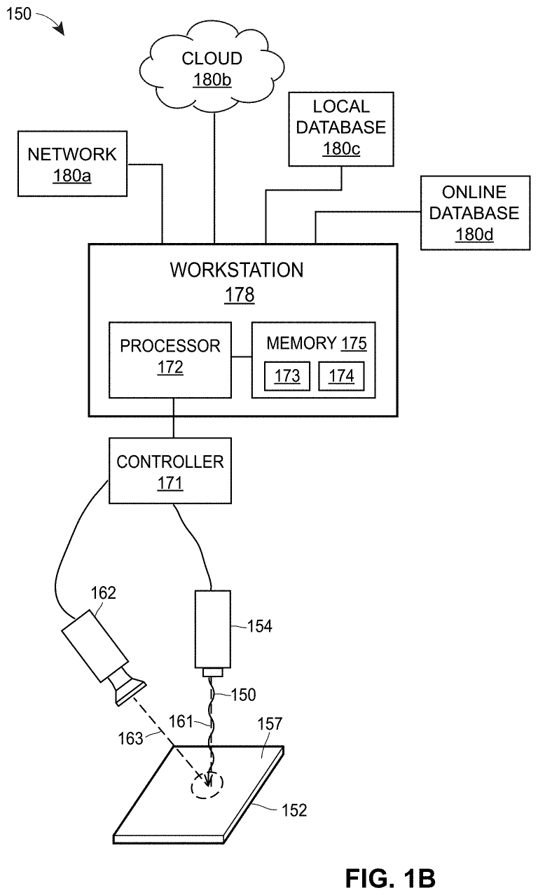

FIG. 1A is a schematic diagram of an AM system 100 for fabricating AM parts and identifying thermal defect signatures to generate a library or database of thermal defect signatures. The system 100 is configured to determine the thermal signatures of AM fabricated parts indicative of the formation and/or presence of subsurface defects. The system 100 includes a target substrate 102 and a radiation source 104 configured to provide radiation 110 to the target substrate 102. The target substrate 102 may be a metallic substrate onto which successive layers of metallic powder may be deposited, wherein the layers of metallic powder form a powder bed 107 on the substrate 102. The radiation source 104 may supply radiation 110 along a beam axis 111 to the powder bed 107 to melt the metallic powder of the powder bed 107 to form a layer being a layer of a fabricated part. Another layer of metallic powder may then be applied to the resultant fabricated part layer, and the radiation source 104 may apply radiation 110 to the new metallic powder layer of the powder bed 107 to melt the metallic powder 107 to create another metallic layer of the AM part. The process of adding a powder layer to the powder bed 107, and applying radiation to the powder layer is repeated multiple times to additively manufacture a metallic part.

The radiation source 104 may be a CO₂ laser, an Nd: YAG laser, a Yb-fiber laser, an excimer laser, a laser coupled to an amplifier, or another type of laser configured to provide radiation capable of melting the metallic powder of the powder bed 107. In embodiments, the radiation 110 may have a wavelength of 9 to 11 microns, 1 to 2 microns, 100 to 500 nanometers, 250 to 750 nanometers, 750 to 1250 nanometers, or greater than 1200 nanometers. In embodiments, the metallic powder may include one or more of copper, iron, tin, titanium, lead, aluminum, or another metal. Although as described herein as a metallic powder, in embodiments, a powder that is not metallic may be used for additive manufacturing. For example, the powder may include one or more of a zinc oxide, aluminum oxide, silicon oxide, tin oxide, copper oxide, silicon carbide, chromium carbide, tin carbide, tungsten carbide, or another ceramic material. Additionally, the powder may include a polymer and/or a mixture of compounds and elements.

The system 100 further includes a thermal sensor (e.g., an infrared camera 112, a near-infrared camera, a remote thermometer, a pyrometer, a single pixel thermal detector, a multiple pixel thermal detector, etc.), an X-ray camera 114, and an X-ray radiation source 117. The infrared camera 112 is configured to capture thermal images of the substrate 102, and the powder bed 107 on the substrate 102, during AM fabrication. The infrared camera 112 has an optical axis 113 that is substantially parallel to the beam axis 111 of the radiation 110 to allow for imaging of the region of the powder bed during an AM fabrication cycle. In embodiments, the relative angle between the optical axis 113 and the beam axis 111 may be 0°, 5°, 10°, 15°, 20°, or 30°. In embodiments, the relative angle between the optical axis 113 and the beam axis 111 may be between 0° and 5°, 5° and 10°, 10° and 15°, 15° and 20°, or 20° to 30°. A thermal history of the substrate 102, or regions of the substrate 102 and/or powder bed 107, may be obtained from the thermal image data and further analyzed. While described herein as being an infrared camera, any thermal sensor may be employed to collect thermal data. For example, a thermal sensor for collecting thermal data may include one or more of a near-infrared camera, a remote thermometer, a pyrometer, a single pixel thermal detector, a multiple pixel thermal detector, or by another device or means for obtaining thermal data remotely.

The X-ray radiation source 117 provides X-ray radiation 120 to the powder bed 107 on the substrate 102. The X-ray camera 114 is configured, relative to the X-ray radiation source 117, to capture X-ray images of the substrate 102 and powder bed 107 during AM fabrication. The X-ray images provide a means to visually inspect the part during fabrication of the part to determine if a subsurface defect has formed. If it is determined from the X-ray images that a subsurface defect has formed, then the thermal history of a region of the AM part, may be analyzed to determine a thermal signature of the formation and/or presence of the subsurface defect.

Together, the X-ray images, and infrared images obtained by the X-ray camera 117 and IR camera 112 allow for the identification of thermal signatures of subsurface defect formation during an AM manufacturing process. Once the thermal signatures of the formation of a subsurface defect have been identified, AM systems may identify the formation and/or presence of subsurface defects from a recorded thermal history of a part during AM manufacturing without the use of an X-ray images, an X-ray camera, or an X-ray radiation source. In embodiments, the thermal signatures corresponding to subsurface defects may be characterized and further provided to AM manufacturing setups that do not include X-ray sources or cameras. A subsurface defect may be identified solely from the use of an infrared camera capturing thermal images during AM manufacturing of a piece.

FIG. 1A further depicts a workstation 128 having one or more processors 122 and a memory 125. In embodiments, multiple processors may be communicatively coupled to multiple corresponding memories. The workstation is communicatively coupled to a controller 121 for controlling various devices for performing AM manufacturing and for identifying thermal defect signatures as described herein. For example, the controller 121 may be in communication, through wired or wireless communication, with the radiation source 104, the X-ray source 117, the infrared camera 112, and/or the X-ray camera 114 to control any of the functions of any devices in communication with the controller. Further, the controller 121 may be in communication with a motor or actuator physically coupled to the substrate 102 for translating the substrate 102. The controller 121 may also collect data from devices in communication with the controller 121 and the controller 121 may provide any collected data to the workstation 128. The workstation 128 may store data received from the controller 121 in the memory 125 in data 125 or data sets.

In embodiments, the workstation 128 may be in direct communication with any of the radiation source 104, the X-ray source 117, the infrared camera 112, the X-ray camera 144, or any other devices for performing the methods described herein, and the workstation 128 may collect data directly from any of the devices in communication with the workstation 128. In embodiments, the processor 122 may analyze data from the devices, and/or perform other actions required for the methods described herein. The one or more processors 122 may be in communication with the memory 125 or multiple processors may be coupled to more than one corresponding memories for storing data 123 and for storing machine readable instructions 124. For example, the memory 125 may store the machine readable instructions 124 for performing image processing, comparing the stored data with obtained image data from the infrared camera 112 and/or the X-ray camera 114, performing data parsing, determining thermal histories, identifying thermal defect signatures, and for performing other operations for identifying subsurface thermal defects as described herein. In embodiments, different processors may execute different machine readable instructions for performing different tasks. For example, one processor may instruct the controller 121 to control the radiation source 121 according to an AM fabrication cycle, while another processor may execute different machine readable instructions causing the processor to obtain infrared images from the infrared camera 112. In embodiments, the workstation 128 may communicate with the controller 121 to control devices communicatively coupled to the controller 121, while image processing and analysis of collected data is performed by the cloud 130b. The memory 125 may store data 123 such as thermal history data, infrared image data, X-ray image data, thermal defect signature data, and hardware specifications and parameters for the infrared camera 112 and/or X-ray camera 114 and other components. In embodiments, the memory 125 may store data 123 that is obtained by the workstation 128 from a network 130a, a cloud 130b, a local database 130c, an online database 130d, and/or another source of data through wired or wireless communication.

FIG. 1B is a schematic diagram of an AM system 150 for fabricating AM parts and detecting subsurface print defects in real-time by comparing thermal histories with identified thermal defect signatures. The system 150 is configured to obtain thermal histories of regions of the powder bed 157 and compare the thermal histories to thermal defect signatures to determine the formation and/or presence of a defect. The system 150 includes a target substrate 152 and a radiation source 154 configured to provide radiation 150 to the target substrate 152. The target substrate 152 may be a metallic substrate onto which successive layers of metallic powder may be deposited, wherein the layers of metallic powder form a powder bed 157 on the substrate 152. The radiation source 154 may supply radiation 160 along a beam axis 161 to the powder bed 157 to melt the metallic powder of the powder bed 157 to form a layer being a layer of a fabricated part. Another layer of metallic powder may then be applied to the resultant fabricated part layer, and the radiation source 154 may apply radiation 160 to the new metallic powder layer of the powder bed 157 to melt the metallic powder to create another metallic layer of the AM part. The process of adding a powder layer to the powder bed 157, and applying radiation to the powder layer is repeated multiple times to additively manufacture a metallic part.

The radiation source 154 may be a CO₂ laser, an Nd: YAG laser, a Yb-fiber laser, an excimer laser, a laser coupled to an amplifier, or another type of laser configured to provide radiation capable of melting the metallic powder of the powder bed 157. In embodiments, the radiation 160 may have a wavelength of 9 to 11 microns, 1 to 2 microns, 100 to 500 nanometers, 250 to 750 nanometers, 750 to 1250 nanometers, or greater than 1200 nanometers. In embodiments, the metallic powder may include one or more of copper, iron, tin, titanium, lead, aluminum, steel, or another metal. Although as described herein as a metallic powder, in embodiments, a powder that is not metallic may be used for additive manufacturing. For example, the powder may include one or more of a zinc oxide, aluminum oxide, silicon oxide, tin oxide, copper oxide, silicon carbide, chromium carbide, tin carbide, tungsten carbide, or another ceramic material. Additionally, the powder may include a polymer and/or a mixture of compounds and elements such as Ti-6Al-4V as described in the examples disclosed herein.

The system 150 further includes an infrared camera 162. The infrared camera 162 is configured to capture thermal images of the substrate 152, and the powder bed 157 on the substrate 152, during AM fabrication. The infrared camera 162 has an optical axis 163 that is substantially parallel to a beam axis 161 of the radiation 160 to allow for imaging of the region of the powder bed 157 during an AM fabrication cycle. A thermal history of the substrate 152, or regions of the substrate 152 and/or powder bed 157, may be obtained from the thermal image data and further analyzed. While described herein as being obtained by the infrared camera 162, thermal data obtained by the system 150 may be obtained by another thermal sensor such as by a near-infrared camera, a remote thermometer, a pyrometer, a single pixel thermal detector, a multiple pixel thermal detector, or by another device or means for obtaining thermal data remotely.

FIG. 1B further depicts a workstation 178 having one or more processors 172 and a memory 175. In embodiments, the memory 175 may be one or more memories. The workstation 178 is communicatively coupled to a controller 171 for controlling various devices for performing AM manufacturing and for identifying thermal defect signatures as described herein. For example, the controller 171 may be in communication, through wired or wireless communication, with the radiation source 154, the X-ray source 167, the infrared camera 162, and/or the X-ray camera 164 to control any of the functions of any devices in communication with the controller 171. Further, the controller 171 may be in communication with a motor or actuator physically coupled to the substrate 152 for translating the substrate 152. The controller 171 may also collect data from devices in communication with the controller 171 and the controller 171 may provide any collected data to the workstation 178. The workstation 178 may store data received from the controller 171 in the memory 175 as the data 123 or as data sets.

In embodiments, the workstation 178 may be in direct communication with any of the radiation source 154, the X-ray source 167, the infrared camera 162, the X-ray camera 164, or any other devices for performing the methods described herein, and the workstation 178 may collect data directly from any of the devices in communication with the workstation 178. In embodiments, the processor 172 may analyze data from the devices, and/or perform other actions required for the methods described herein. The one or more processors may be in communication with a memory 175 or multiple processors may be coupled to multiple corresponding memories for storing data 173 and for storing machine readable instructions 174 and routines. For example, the memory 175 may store machine readable instructions 174 for performing image processing, comparing the stored data with obtained image data from the infrared camera 162, performing data parsing, determining thermal histories, identifying thermal defect signatures, and for performing other operations for identifying subsurface thermal defects as described herein. In embodiments, different processors may execute different machine readable instructions for performing different tasks. For example, one processor may instruct the controller 171 to control the radiation source 154 according to an AM fabrication cycle, while another processor may execute different machine readable instructions causing the processor to obtain infrared images from the infrared camera 162. In embodiments, the workstation 178 may communicate with the controller 171 to control devices communicatively coupled to the controller 171, while image processing of images, and analysis of collected data is performed by the cloud 180b. The memory 175 may store data 173 such as thermal history data, infrared image data, X-ray image data, thermal defect signature data, and hardware specifications and parameters for the infrared camera 162 and other components. In embodiments, the memory 175 may store data 173 that is obtained by the processor 172 from a network 180a, a cloud 180b, a local database 180c, an online database 180d, and/or another source of data through wired or wireless communication.

The infrared images obtained by the IR camera 162 may further be processed by image processing routines in the machine readable instructions 174 stored on the memory 175. The machine readable instructions 174 may additionally cause the processor 172 to analyze the obtained infrared images to determine a thermal history of a region of the powder bed 157. The determined thermal history may be compared to thermal defect signatures of the data 173 stored on the memory 175 to determine in a defect has formed and/or is present in the piece. In embodiments, the thermal signatures corresponding to subsurface defects may be characterized and the fabrication lasing parameters that formed the defect may be stored in the data 173. Ranges of parameters that do not form a defect may then be determined by the processor to reduce the number of defects in parts, to reduce the time and money required to fabricate defect-free, or minimal defect pieces.

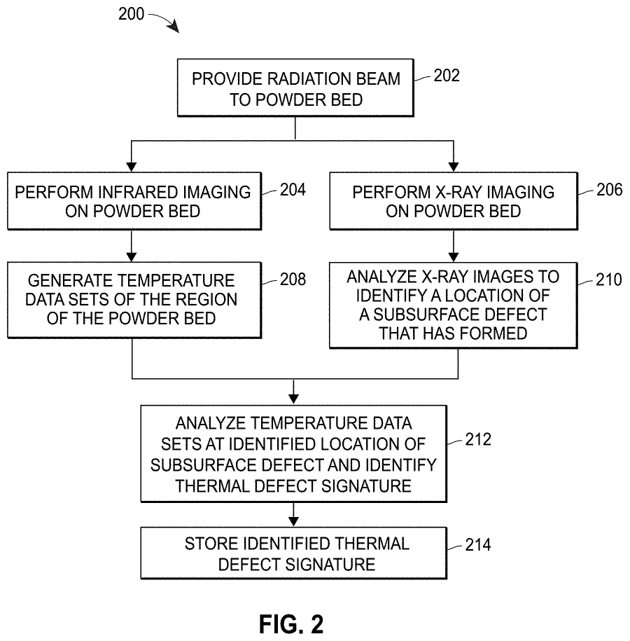

FIG. 2 is a flow diagram of an embodiment of a method 200 for identifying thermal signatures of subsurface defect formation during an AM fabrication cycle. While described commonly herein as being performed during an AM fabrication cycle, the techniques disclosed for detecting a thermal defect signature may be performed in-situ after a piece has been fabricated. For example, a piece may be reheated by an oven structure or laser radiation and the thermal defect signature(s) may be identified by an infrared camera as the part cools. The method 200 may be performed by an AM system such as the AM system 100 of FIG. 1A. Referring simultaneously to FIGS. 1A and 2, the method 200 includes providing, by the radiation source 104, the beam of radiation 110 to a region of powder bed 107 (block 202). The radiation 110 is provided to the region of the powder bed 107 to melt the region of the powder bed to form a layer of an AM part or piece. The radiation 110 may be laser radiation or another radiation for melting the powder bed 107.

The method 200 further includes performing, by the infrared camera 112, infrared imaging of the region of the powder bed 107 while the radiation is being provided to the powder bed 107 (block 204). In embodiments, the infrared image captured by the infrared camera 112 may be a raster image, or an image that is made up of a plurality of image pixels. The infrared camera 112 may be configured to have a field of view that is focused along the optical axis 113 that is substantially parallel to a beam propagation axis 111 of the radiation 110 to allow for imaging of the region of the powder bed 107 during an AM fabrication cycle. In embodiments, the infrared camera 112 may take a plurality of infrared images of the powder bed 107, with each infrared image being captured at a different time. The workstation 128 may obtain the plurality of infrared images from the controller 121, or directly from the infrared camera 112 and the processor 122 may then generate, from analysis of the plurality of infrared images, a plurality of temperature data sets of the region of the powder bed 107 (block 208). While described herein as being determined by an analysis of the plurality of infrared images, the thermal data sets of the region of the powder bed may be determined from thermal data obtained by any thermal sensor such as a near-infrared camera, a remote thermometer, a pyrometer, a single pixel thermal detector, a multiple pixel thermal detector, or by another device or means for obtaining thermal data remotely. Each temperature data set of the temperature data sets is generated by analyzing a corresponding infrared image of the plurality of infrared images, and therefore, the resulting temperature data sets may be indicative of the temperature of the powder bed 107 over time. Further analysis of the temperature data sets, and subsets of pixels within the temperature data sets, may then provide a thermal history or thermal timeline of the region of the powder bed 107, as described further herein.

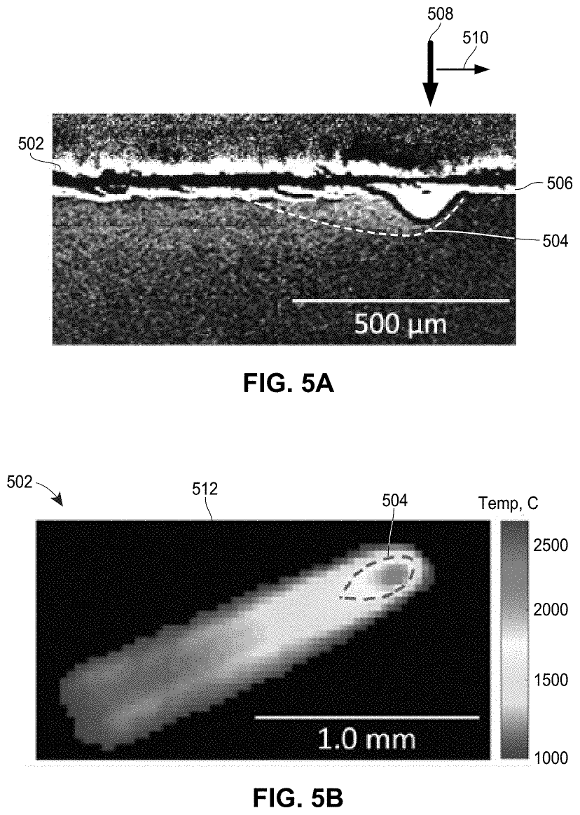

The controller 121 controls the X-ray camera 107 to perform X-ray imaging of the region of the powder bed 107 while the first radiation is being provided to the powder bed 107 (block 206). The X-ray imaging may be performed simultaneously with the infrared imaging. The controller 121 may control the X-ray source 117 to provide X-ray radiation 120 to the powder bed 107 and the X-ray camera 114 may then image the region of the powder bed 107 during an AM fabrication cycle. The workstation 128 then obtains the X-ray images, and the processor 122, or a user of the system 100, may analyze the X-ray images to determine if a subsurface defect has formed during the AM fabrication cycle. Further, the user of the system 100, or processor 122, may determine from the X-ray images a location in the part where the subsurface defect has formed (block 210). As discussed further in reference to FIG. 5A, the X-ray images provide side view visible images of an AM part during the AM fabrication cycle. The X-ray images allow for defects to be visually identified by a user of the system 100, or identified by the processor 122 executing the machine executable instructions 124 and performing image processing techniques. In embodiments, the X-ray camera 107 may have pixel sizes of 1 to 10 microns, 5 to 20 microns, 10 to 50 microns, 50 to 100 microns, 100 to 500 microns, or larger than 500 microns. In embodiments, the X-ray camera may have a temporal resolution of 10 to 50 kHz, 50 to 100 kHz, 100 to 500 kHz, 500 kHz to 1 MHz, or 1 MHz to 5 MHz. As described further in reference to the X-ray images of FIGS. 5A, 7A, and 8A, the X-ray camera 107 may have a pixel size of 1.97 microns with temporal image resolutions between 50 and 60 kHz.

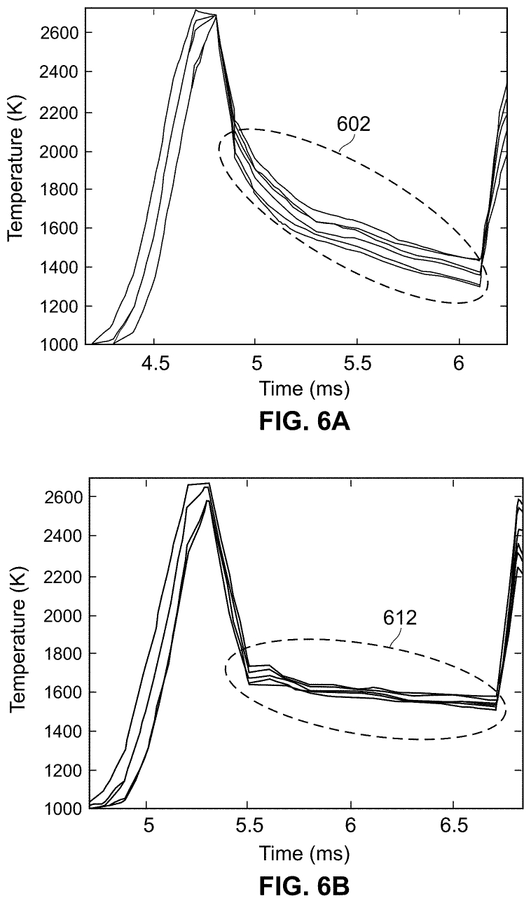

The temperature data sets, or a subset of data in the temperature of data sets, are then analyzed by the processor 122, and the processor 122 determines a thermal defect signature of the subsurface defect (block 212). In embodiments, the thermal defect signature may be identified by a user of the system 100 through analysis of a plot of temperature versus time indicative of a thermal history for a region of the powder bed 107, or fabricated part. Alternatively, the processor 122 may identify the thermal defect signature by analyzing the temperature data sets and comparing the thermal history of the region of the powder bed 107 to thermal histories from regions of the powder bed 107 that do not contain a subsurface defect. The processor 122 may be provided with a non-defect thermal history (e.g., a temperature versus time data fit or regression) that the processor 122 compares with thermal histories of regions having a subsurface defect to identify one or more thermal defect signatures of the subsurface defect. In embodiments, and discussed further in reference to FIGS. 6A and 6B, 7A-7D, and 8A-8D a thermal defect signature may include a change in a cooling rate of the region of the powder bed, an increase in temperature in a post-solidification period of the thermal history of the region of the powder bed, a change in minimum temperature of a cooling period, or another thermal signature identified in the temperature data sets and thermal histories. Additionally, the thermal signature may depend on the type of material of the powder, and also on the size, location, and shape of the subsurface defect. After the thermal defect signature has been identified, the processor 122 may store the identified thermal defect signature and/or the corresponding temperature data representative of the thermal defect signature in the data 123, on the network 130a, cloud 130b, local database 130c, online database 130d, or on another network or database, for further use or retrieval by users, processors, and AM manufacturing systems (block 214).

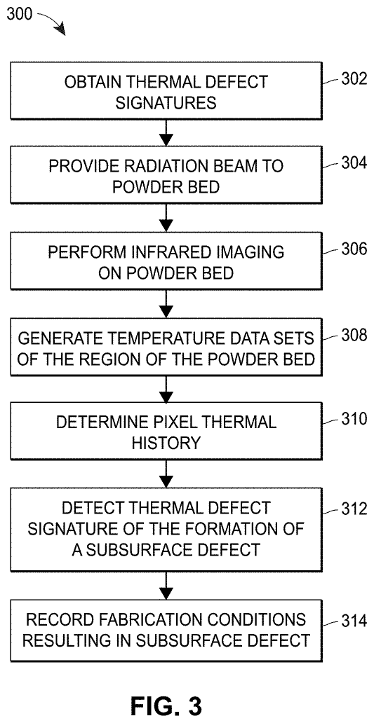

FIG. 3 is a flow diagram of an embodiment of a method 300 for detecting subsurface defect formation and/or presence during an AM fabrication cycle using thermal signatures, such as the thermal signatures identified by the method 200 of FIG. 2. The method 300 of FIG. 3 may be performed by an AM system such as the AM system 200 of FIG. 1B. It should be noted that the method 300 of FIG. 3 does not require X-ray imaging, and therefore, the method 300 of FIG. 3 may be performed by the AM system 100 of FIG. 1A, but the X-ray source 117 and X-ray camera 114 are not used and therefore not required.

Referring simultaneously to FIGS. 1B and 3, the method 300 includes obtaining by the processor 172, from the data 173 stored on the memory 175, one or more thermal defect signatures indicative of the formation and/or presence of a subsurface defect during AM fabrication (block 302). In embodiments, the processor 172 may obtain the one or more thermal defect signatures from the data 173 stored on the memory 175, from the network 180a, from the cloud 180b, from the local physical database 180c, and/or from the online database 180d. Further, the processor 172 may obtain the one or more thermal signatures through a wired or wireless connection. Additionally, a user may input the thermal defect signature through a user interface communicatively coupled to the processor 172. For example, a user may manually input the thermal defect signature through a keyboard, touchscreen, or other user interface thermal data indicative of one or more thermal signatures to the processor. In any embodiments, the processor 172 may store the obtained thermal defect signatures on the memory 175 in a library of thermal defect signatures. In embodiments, the library of thermal defect signatures may include one or more thermal defect signatures, and/or one or more thermal histories having identified thermal defect signatures. In embodiments, the library of thermal defect signatures may also include one or more thermal histories identified as not having a thermal defect signature to provide a comparison of a non-defect thermal histories with thermal histories having a thermal defect signature.

The method 300 further includes providing a beam of radiation, such as the beam 160 provided by the radiation source 154, to a region of the powder bed 157 (block 304). In embodiments, the radiation 160 may be laser radiation, or any radiation having an intensity and energy capable of melting the metallic powder to form a layer of an AM part or piece.

The controller 171 controls the infrared camera 162 to perform infrared imaging on the region of the powder bed 157 while the radiation 160 is provided to the powder (block 306). The infrared imaging may be performed on the region of the powder bed 157 for a period of time after the radiation 160 has been provided to the powder bed 157 to obtain thermal history data sets of the region of the powder bed 157. In embodiments, the infrared imaging may be performed on the region of the powder bed 157 for 1 millisecond, 2 milliseconds, 5 milliseconds, 8 milliseconds, 10 milliseconds, 1 to 6 milliseconds, 5 to 12 milliseconds, or greater than 10 milliseconds after the radiation 110 has been provided to the region of the powder bed 157. In embodiments, the infrared imaging may be performed on the region of the powder bed 157 for an amount of time that is dependent on the cooling or heat dissipation of the powder bed and/or AM piece, which may be material dependent, piece geometry dependent, dependent on the provided radiation 160, or depend on another feature of the AM manufacturing cycle and environment of the AM system 150 (e.g., environmental temperature, pressure, etc.). In embodiments, the infrared imaging may be performed on the region of the powder bed 157 before, during, and after the radiation is provided to the powder bed 157 to obtain more temperature data for determining one or more thermal histories of the region of the powder bed 157. In embodiments, the infrared imaging may be obtained at a frame rate of 100 to 400 frames per second, 300 to 700 frames per second, 500 to 1000 frames per seconds, or greater than 1000 frames per second. In embodiments, the pixels may be 2 to 10 microns, 10 to 50 microns, 50 to 100 microns, or greater than 100 microns. In embodiments, the infrared imaging may have a spatial resolution of 2 to 10 microns per pixel, 10 to 50 microns per pixel, 50 to 100 microns per pixel, or greater than 100 microns per pixel. In embodiments, the infrared imaging may have a temporal image resolution of 10 to 100 microseconds, 50 to 200 microseconds, 100 to 500 microseconds, 500 microseconds to 1 millisecond, 1 millisecond, 2 milliseconds, 5 milliseconds, 8 milliseconds, 10 milliseconds, 1 to 6 milliseconds, 4 to 10 milliseconds, 8 to 12 milliseconds, or greater than 12 milliseconds. While described herein as being obtained by the infrared camera 162, temperature data obtained by the system 150 for the method 300 may be obtained by another thermal sensor such as a near-infrared camera, a remote thermometer, a pyrometer, a single pixel thermal detector, a multiple pixel thermal detector, or by another device or means for obtaining thermal data remotely.

The method 300 further includes generating, by the processor 122, temperature data sets of the region of the powder bed 157 (block 308). In embodiments, a temperature data set may include a two dimensional array of temperature values, wherein each of the temperature values represents the temperature of a pixel of a corresponding infrared image. Each temperature value and corresponding pixel is indicative of the temperature of a region in two dimensional coordinate space of the imaged powder bed 157. In embodiments, each temperature data set of the temperature data sets may be derived from a corresponding infrared image frame of a plurality of infrared images. Each infrared image frame may be captured by performing infrared imaging of the region of the powder bed 157 at a different time than other infrared image frames of the plurality of infrared images. For example, 10 image frames of the region of the powder bed 157 may be obtained over a period of 5 milliseconds, and 10 corresponding temperature data sets may be determined by analyzing each of the 10 infrared image frames.

The processor 172 then determines the thermal history of each pixel of the infrared image frames (block 310), for example, by plotting or analyzing, by the processor 122, the temperature value of each pixel over time sequentially from the first image frame obtained to the 10th (or otherwise final, in embodiments other than the present example), image frame obtained. Therefore, as a whole, the temperature data sets (e.g., 10 in the current example) may be a three dimensional matrix of values, with two dimensions being coordinate space values of the powder bed 157, and the third dimension being time.

In embodiments, the processor 172 may identify one or more pixels of interest and the processor 172 may determine thermal histories of the one or more pixels of interest. Identifying one or more pixels of interest may reduce the amount of data processing, time, energy, and resources to perform the method 300 of FIG. 3. For example, in embodiments, the processor 172 may analyze an obtained plurality of infrared images to determine, and track, a hot spot of the plurality of infrared image. The hot spot may be determined to be a region of an infrared image that indicates a highest temperature of the powder bed 157. In embodiments, the processor 172 may identify the hot spot as a region of the image that indicates a temperature above a temperature threshold (e.g., above 1800 K, above 2000 K, above 2200 K, or above another temperature threshold). A hot spot may be determined to be one or more pixels of the infrared image, and hot spots for different images may contain one or more of the same pixel. For example, two consecutive images in time may have some overlap of pixels for each respective hot spot due to a radiation scanning speed of the radiation source, spatial resolution of the infrared camera, and frame rate of the infrared camera. The processor 172 may then determine pixels of interest as only those pixels of infrared images that were determined to be part of a hot spot. In embodiments, the imaging of one or more of the identified hot spots may be performed for 2 milliseconds, 5 milliseconds, 7 milliseconds, from 1 to 5 milliseconds, 4 to 8 milliseconds, or for greater than 8 milliseconds. The processor 172 may then determine and analyze only the thermal histories of the pixels of interested to determine if a subsurface defect has formed during fabrication. Reducing the number of pixels down to a subset of pixels of interest may greatly reduce the processing time, and energy required to detect the formation of a subsurface defect during real-time AM fabrication.

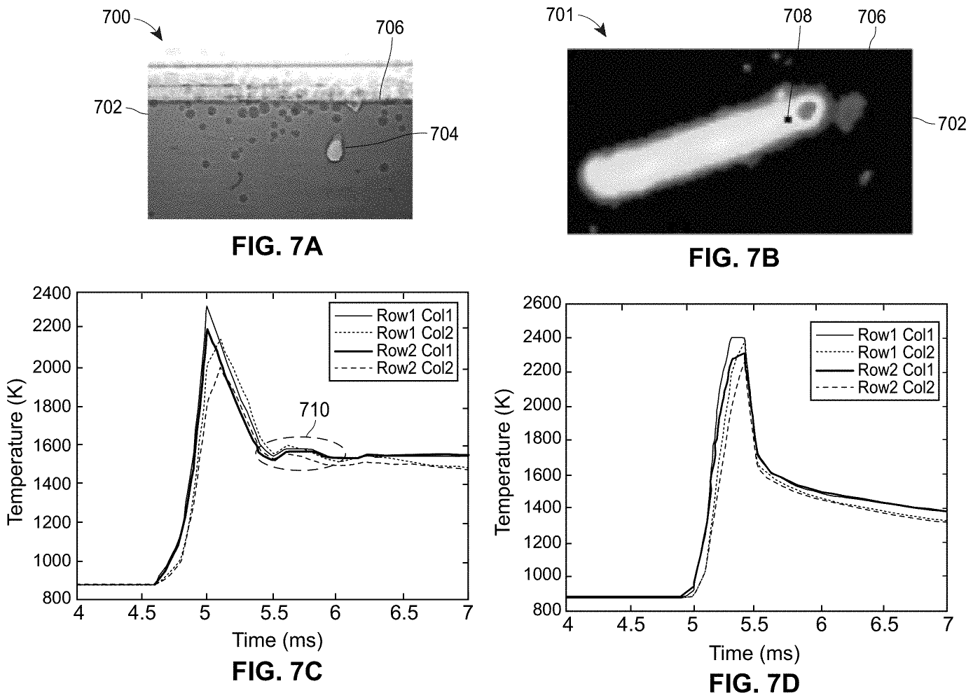

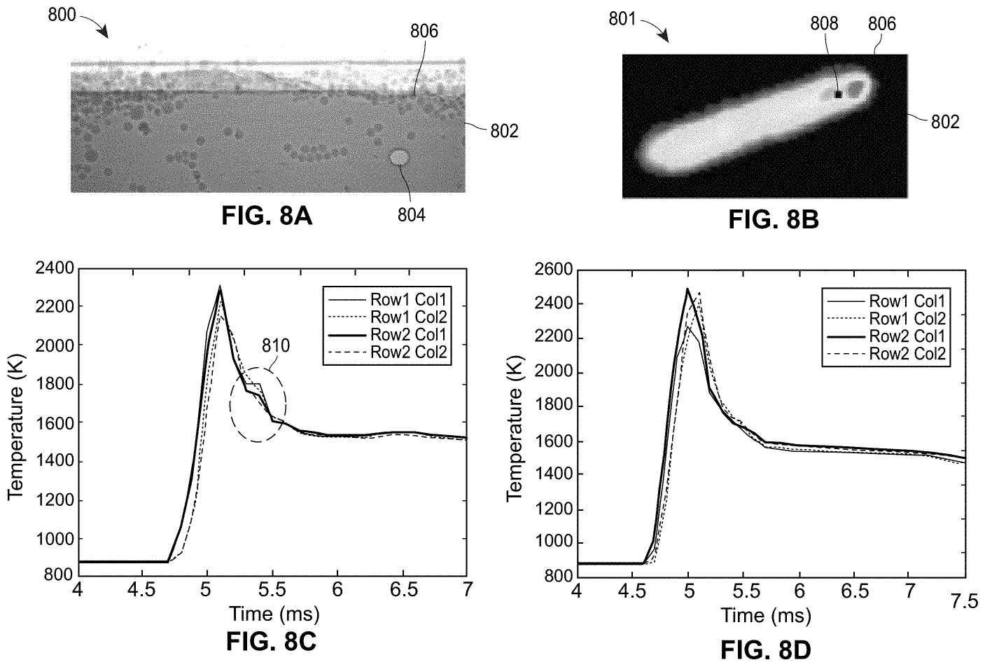

Once one or more pixel thermal histories have been determined, the method 300 includes detecting, by the processor 172, a thermal defect signature of the formation and/or presence of a subsurface defect in the region of the powder bed 152 or AM piece (block 312). To detect the thermal defect signature, the processor 172 may compare a pixel's determined thermal history to one or more of the thermal defect signatures, or thermal histories, in the library of thermal defect signatures of the data 173 stored in the memory 175. In embodiments, subsets of data in a pixel's thermal history may be analyzed to detect the thermal defect signature. For example, features of the pixel's determined thermal history (e.g., a local temperature maximum or minimum, a global temperature maximum or minimum, a rate of temperature increase or decrease, a change in the rate of temperature increase or decrease, etc.) may be identified as a feature of interest to compare to the thermal defect signatures in the library of thermal defect signatures. In embodiments, a mathematical fit or regression of the thermal history of the pixel may be determined and compared to thermal defect signatures in the library of thermal defect signatures. It may be determined that the piece has a subsurface defect if the thermal history, or a regression of the thermal history, of the pixel contains features that are also contained in one or more thermal defect signatures of the library of thermal defect signatures. In embodiments, a threshold of a feature of a pixel's thermal history may be used to determine if a defect has formed. For example, a decrease in cooling rate of 3% may be determined not to indicate the formation and/or presence of a subsurface defect, but a decrease in cooling rate of 5% may indicate that a subsurface defect has formed. Examples of specific thermal defect signatures, and features of thermal histories for detecting the formation and/or presence of a subsurface defect are discussed further herein in reference to FIGS. 7A-7D, and 8A-8D.

In some embodiments, to detect the thermal defect signature, the processor 172 may compare a pixel's determined thermal history to one or more thermal histories in the library of thermal defect signatures that was determined not to contain a thermal defect signature, referred to as a “non-defect thermal history” for clarity. Features of the pixel's determined thermal history may be identified as a feature of interest to compare to the non-defect thermal histories in the library of thermal defect signatures. In embodiments, a mathematical fit or regression of the thermal history of the pixel may be determined and compared to the non-defect thermal histories. It may be determined that the piece has a subsurface defect if the thermal history, or a regression of the thermal history, of the pixel contains features that are not present in one or more non-defect thermal histories of the library of thermal defect signatures.

Once the formation and/or presence of a subsurface defect has been detected, the processor 172 may then record in the memory 125, provide to the network 180a, provide to a user in real-time, provide to the cloud 180b, provide to a local database 130c, provide to an online database 130d, or otherwise store a set of fabrication conditions (e.g., applied laser or radiation power, laser or other radiation scanning speed, etc.) that resulted in the formation of the subsurface defect (block 314). The conditions resulting in the formation of the subsurface defect may then be avoided in subsequent AM fabrication cycles, the subsurface defect may be corrected, the fabrication of the part having the subsurface defect may be terminated, etc.

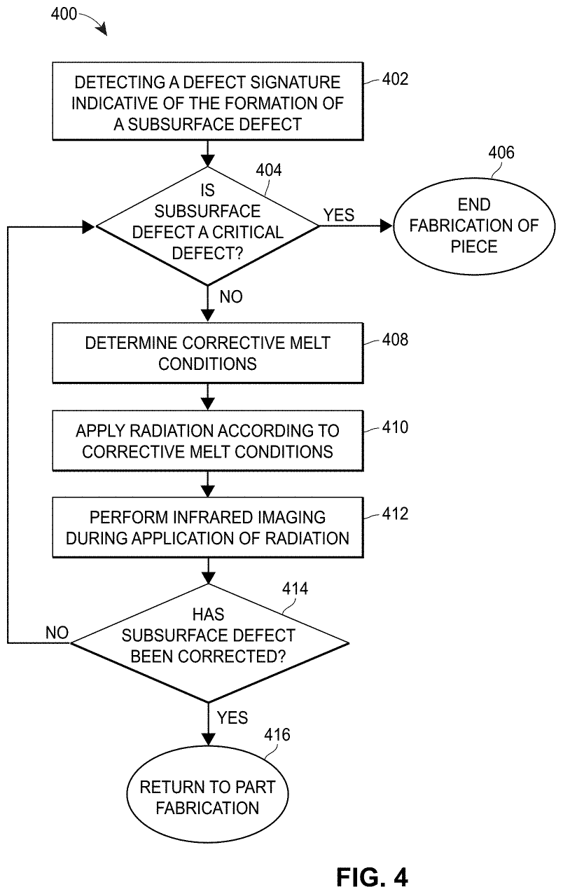

FIG. 4 is a flow diagram of an embodiment of a method 400 for determining if the fabrication of a part should be aborted, or if the correction of a subsurface defect should be attempted. The method 400 of FIG. 4 allows an operator of an AM system, or a processor controlling the AM system, to determine whether an attempt to fix a defect should be performed (i.e., a non-critical defect) in real-time during fabrication of the part, which removes the need for expensive and time consuming post print qualification techniques (e.g., piece tomography). If the subsurface defect has been identified as a non-critical defect, then a corrective action (e.g., performing laser re-melting, or otherwise providing a second radiation to the powder bed) can be performed that removes or otherwise corrects the defect.

The method 400 of FIG. 4 may be performed by an AM system such as the AM systems 100 of FIGS. 1A and 150 of FIG. 1B. Referring now simultaneously to FIGS. 1A and 4, the method 400 includes detecting, by the system 100, a defect signature indicative of a subsurface defect in a piece during fabrication (block 402). The subsurface defect signature may be a thermal defect signature that is detected by either of the methods 200 and 300 of FIGS. 2 and 3 respectively. Further, the defect signature may be indicative of a size, location, depth, and/or geometry of the subsurface defect. The method 400 of FIG. 4 further includes determining, by the processor 122, if the subsurface defect is a critical defect (block 404). A critical defect may include a pore, a void, and/or a crack that is at a location that may cause piece failure or compromise the reliability of the piece. For example, a critical defect may be any defect that alters the hardness of the piece causing the piece to break under less strain than is required for the piece to function properly in use. A critical defect may be any defect that changes the physical properties of a piece beyond a threshold for proper or required functionality. The physical properties of the piece that the defect may affect may include a density, melting point, hardness, brittleness, elasticity, malleability, plasticity, strength, stiffness, and/or thermal conductivity.

In embodiments, the size, location, and geometry of the defect may be used to determine if the subsurface defect is a critical defect. For example, in embodiments, an AM fabricated cylindrical piece may be required to sustain applied torque forces on each end of the cylinder. Therefore, a keyhole pore located at the center of the cylinder, along the length of the cylinder, may be considered a critical defect due to the likelihood of piece failure under stress from the torque during operation. Alternatively, a keyhole pore near an end of the cylinder may not be considered a critical defect due to the amount of force and stresses/strains experienced at the location of the non-central keyhole pore. In another example, a defect may occur in an AM fabricated piece at a location having a curve or other geometry that may cause additional structural problems if a laser rescan is attempted, which may be determined to be a critical defect. In any embodiment, a subsurface defect, for a given piece, may be determined to be a critical defect based on the size, location, depth, geometry, and/or type of the defect.

If, at block 404, the subsurface defect has been determined by the processor 122 to be a critical defect than an operator of the AM system 100, or the processor 122 controlling the process, may end the fabrication of the piece before the piece is completed (block 406). Ending the fabrication before completion of the piece saves money, time, and manufacturing materials. Additionally, the piece will have been determined not to be salvageable and therefore no further post print qualification techniques are required.

If, at block 404, the subsurface defect is determine to be a non-critical defect, than the processor 122 may determine a set of corrective melt conditions (block 408). The radiation source 104 may apply a second radiation corresponding to the corrective melt conditions to the piece to re-melt the piece in the region of the subsurface defect, which may result in removal of the defect. Examples of removing the defect include apply a second radiation to the piece to re-melt materials around a crack to form a solid region, and/or to re-melt materials allowing trapped fluid (i.e., gas, vapor, liquid, molten material) within a subsurface pore to escape from a surface of the piece. The specific corrective melt conditions required to remove the defect depend on the material of the piece, geometry of the piece, the type of applied radiation, and the characteristics of the subsurface defect (e.g., size, location, depth, geometry, type of defect, etc.). In embodiments, the set of corrective melt conditions of the applied second radiation may include a radiation power, radiation energy, radiation scan speed, radiation scan pattern, an applied radiation time, or another AM fabrication condition capable of re-melting and correcting a subsurface defect. In embodiments, the applied radiation time of the corrective melt conditions may be between 10 to 100 milliseconds, from 50 to 200 milliseconds, from 100 to 500 milliseconds, or greater than 500 milliseconds depending on the size, geometry, and depth of the subsurface defect in the piece.

The controller 121 may then control the radiation source 104 to apply the radiation 110 to the piece according to the determined corrective melt conditions (block 410). The controller 121 may control the infrared camera 112 to performed infrared imaging of the region of the defect while the radiation is applied to the defect (block 412), and the processor 122 may execute machine readable instructions 124 to determine if the defect has been corrected (block 414). To determine if the defect has been corrected, the processor 122 may generate and analyze pixel thermal histories as described in reference to the method 300 of FIG. 3. In embodiments, X-ray imaging may also be performed, by the X-ray camera 114, on the piece to determine if the defect has been corrected. If it is determined that the defect has not been corrected, then the method 400 returns to block 404 and the processor 122 determines if the defect is a critical defect. If it is determined that the defect is not critical, than the processor 122 may determine new corrective melt conditions at block 408, and the new corrective melt conditions may be applied to the region of the piece having the subsurface defect (block 410). The processor 122 may perform the method iteratively until the defect is determined to be corrected at block 414.

If, after applying radiation according to the corrective melt conditions, the defect has changes location, size, geometry, and/or new defects have formed, the processor 122 may determine that the subsurface defect, or defects, are critical at block 404 and that the fabrication should be ended at block 406.

If, at block 414, the processor 122 determines that the defect has been corrected, then method 400 returns to fabricating the part at block 416. Returning to part fabrication may include applying a new powder layer to the piece and performing a next iteration of method 300 of FIG. 3 for fabricating the next piece layer of an AM piece. The processor 122 may perform the method 400 of FIG. 4 any time during piece fabrication when a subsurface defect has been detected. In embodiments, the processor 122 performs the method 400 as soon as a subsurface defect has been detected. In other embodiments, the processor 122 performs the method 400 at the end of a radiation scan for a given layer of a piece, which may allow for multiple subsurface defects to be corrected before returning to fabrication of the AM piece. Further, it may be beneficial to correct subsurface defects before the melting of more layer of powder beds, and therefore, layering of the AM piece, which may reduce the amount of radiation required for correction of the subsurface defect.

FIGS. 5A and 5B are corresponding X-ray and infrared images, respectively, of a melt pool 504 of a powder bed 502 during the application of radiation 508 to a powder bed 502. FIG. 5A is a side view of the powder bed 502, and FIG. 5B is a top-down view of the powder bed 502. The X-ray images of FIGS. 5A, 7A, and 8A have pixels sizes on the order of microns (i.e., approximately 1.97 microns) with temporal resolutions between 50 and 60 kHz. Additionally, the powder used for the examples and images of FIGS. 5A, 5B, 7A-7D, and 8A-8D is Ti-6Al-4V, which has a solidus point of approximately 1877 K, and the powder used for the plots of FIGS. 6A and 6B is 4140 steel which has a solidus point of approximately 1689 K. The melt pool 504 of FIGS. 5A and 5B is an example of a melt pool that may be imaged during AM fabrication of a piece. The melt pool 504 is a region of the powder bed 502, and potentially layers of the piece underneath of the powder bed, that have melted due to the applied radiation 508 during the AM process. After the application of the radiation 508, the melt pool 504 subsequently cools and hardens into a solid. As previously described, subsurface defects such as cracks, and pores may form during solidification of the melt pool 504. Further, a thermal defect signature, during post solidification cooling of the piece, may be identified and used for detecting subsurface defects in real time during AM fabrication, as previously described in reference to the methods 200 and 300 of FIGS. 2 and 3.

FIG. 5A shows a side view X-ray image of the powder bed 502 having a surface 506 and the melt pool 504, during the application of radiation 508 to the powder bed 502. The radiation 508 is applied in a laser scan direction 510 from left to right in the FIG. 5A, and therefore, the melt pool moves across the powder bed 502 from the left to the right in FIG. 5A as well. FIG. 5B further illustrates the motion of the melt pool 504, and provides a visual representation of a thermal

gradient on the surface 506 of the powder bed 502. The X-ray image of FIG. 5A is an example of a side view X-ray image of a piece that may be analyzed to identify if a subsurface defect has formed for identifying thermal defect signatures during AM fabrication of the piece, as described herein.

FIG. 5B shows a top view infrared image of the powder bed 502. Infrared imaging provides thermal information of a field of view as evidenced by the temperature gradient shown in FIG. 5B. The melt pool 504 is in the region of the infrared image having the highest temperatures. The radiation 508 (shown in FIG. 5A) is being provided to the powder bed 502 in a diagonal direction 512 from left to right across the image of FIG. 5B. The powder bed 502 cools after the radiation 508 has been provided, as evidenced by the temperature gradient increasing from lower temperatures on the left, to higher temperatures on the right. The infrared image of FIG. 5B is an example of an infrared image for determining thermal histories of pixels, identifying thermal defect signatures, and detecting the formation and/or presence of a defect during AM fabrication, as described herein. For example, a pixel may be defined as a 0.1×0.1 mm square in the image of FIG. 5A. Multiple infrared images may be obtained and thermal histories may be determined for each pixel, or a subset of pixels, and thermal defect signatures may be identified or detected to determine the formation and/or presence of a subsurface defect, as described herein.

FIG. 6A is a plot of temperature versus time data for a region of a powder bed exhibiting no formation and/or presence of a subsurface defect. The temperature versus time data represents the thermal history for the region of the powder bed. Each of the curves plotted in FIG. 6A represents temperature data derived from a different pixel of a group of six adjacent pixels in a 3×2 pixel array of a rectangular region of the powder bed. The temperature of the region of the powder bed increases between approximately 4.2 to 4.8 milliseconds as the radiation source scans toward the region of the powder bed, creating a melt pool in the region of the powder bed. A maximum temperature of nearly 2700 K is reached, by all of the pixels, between approximately 4.7 and 4.8 milliseconds. The region of the powder bed begins to cool and enters a post-solidification period 602 between approximately 4.8 and 5 milliseconds. The post-solidification period of the region of the powder bed is defined as the time after the solidus point, or solidus temperature, has been reached by the cooling powder bed. For example, as previously mentioned in reference to FIG. 6A, the maximum temperature of 2700 K is reached between 4.7 and 4.8 milliseconds, while the solidus point for the 4140 steel (i.e., ˜1689 K) is reached between 4.9 to 5 milliseconds, after which is the post-solidification cooling period 602. The post-solidification cooling period 602 may include the time the solidus point is reached in addition to time after the solidus point has been reached. The post-solidification cooling rate is the temperature change, and specifically, how the region cools during the post-solidification period 602. The post-solidification cooling rate may be analyzed to detect the formation and/or presence of a subsurface defect, as further described in comparing FIGS. 6A and 6B. In FIG. 6A, the thermal histories of the six pixels exhibit similar post-solidification cooling rates. The various thermal histories of different defect free pixel regions can be averaged to determine a defect free thermal history signature or profile, and therefore, the defect free thermal histories, or a signature or profile derived from the defect free thermal histories, may be used as a standard to determine thermal defect signatures as described herein. While described in embodiments herein as detecting or identifying a defect signature in the post-solidification period 602, thermal data from any time during cooling of the powder bed may be used to detect, or identify a thermal defect signature. For example, it is envisioned that a cooling rate, or change in cooling rate, any time after the maximum temperature has been reached may be used to identify and/or detect a thermal defect signature.

FIG. 6B is a plot of temperature versus time data for a region of a powder bed that has formed a subsurface defect. Similar to FIG. 6A, each of the curves plotted in FIG. 6B represents temperature data derived from a different pixel of a group of six adjacent pixels in a 3×2 pixel array of a rectangular region of the powder bed. The set of 6 pixels of FIG. 6B is the same set of 6 pixels observed in FIG. 6A with the difference that in FIG. 6A the pixels image a region of a powder bed that does not have a defect, and in FIG. 6B the pixels image a region of a powder bed having a defect. The region of the powder bed having the subsurface defect increases in temperature at a similar rate, and with a similar maximum temperature, as exhibit by the region of the powder bed of FIG. 6A. In embodiments, the rate of temperature increase and the maximum temperature may be dependent on the powder bed material or materials, the intensity of the applied radiation, the energy of the applied radiation, laser scan speed, and/or other material and laser scan parameters.

As the region of the powder bed begins to cool after reaching a temperature maximum of nearly 2700 K, the region of the powder bed enters the post solidification period 612, after the solidus point has been reached, near between 5.3 and 5.5 ms. A significant decrease in the post-solidification cooling rate of the pixels of the region having the subsurface defect is observed at approximately 5.5 milliseconds. Additionally, the post solidification cooling rate exhibited in FIG. 6B is roughly a piecewise linear function with minimum temperature of greater than 1400 K, while the post-solidification cooling rate in FIG. 6A is not linear and exhibits a minimum temperature of less than 1400 K. The difference of the post-solidification cooling rate, or the absolute value of the post-solidification cooling rate, cooling trend (e.g., linear, exponential, etc.), and the minimum temperature are three examples of features that may be used to determine thermal history profiles, and thermal signatures, of regions of powder beds with, and without, the formation and/or presence of a subsurface defect.

FIGS. 7A and 7B are, respectively, a side view X-ray image 700, and top-down view infrared image 701 of a powder bed 702 having a surface 706 and a subsurface defect 704, during the application of radiation to the powder bed 702. The infrared image 701 further includes a pixel region 708 of 4 pixels in a 2 by 2 pixel array, with the pixel region 708 being a region of the powder bed 702 containing the subsurface pore 704. FIG. 7C is a plot of temperature versus time data for the pixel region 708, while FIG. 7D is a plot of temperature versus time data for a pixel region of the powder bed 702 that does not include a subsurface defect (not illustrated).

The thermal history curves of FIG. 7C exhibit an subsurface defect signature, demarcated by the dotted ellipse 710, as a post-solidification increase in temperature (i.e., a change of a negative slope of temperature change over time to a positive slope of temperature change over time), while, as illustrated in FIG. 7D, no such post-solidification increase in temperature exists in the thermal history of the region of the powder bed without the subsurface defect. Additionally, the post-solidification cooling rate is decreased for the region of the powder bed having the subsurface defect, resulting in a minimum temperature of greater than 1500 K, as compared to a minimum temperature of less than 1400 K for the region without the subsurface defect. Each of the post-solidification temperature increase, post-solidification cooling rate, and minimum temperature may be used to identify profiles for regions of a powder bed having a subsurface effect as described herein.

FIGS. 8A and 8B show another example of a side view X-ray image 800, and a top-down view infrared image 801 of a powder bed 802 having a surface 806 and a subsurface defect 804, during the application of radiation to the powder bed 802. The infrared image 801 further includes a pixel region 808 of 4 pixels in a 2 by 2 pixel array, with the pixel region 808 being a region of the powder bed 802 containing the subsurface pore 804. FIG. 8C is a plot of temperature versus time data for the pixel region 808, while FIG. 8D is a plot of temperature versus time data for a pixel region of the powder bed 802 that does not include a subsurface defect (not illustrated).

Similar to the thermal history curves of FIG. 7C, the thermal history curves of FIG. 8C exhibit a subsurface defect signature 810 as a post solidification increase in temperature, while the thermal history curves of FIG. 8D exhibit no thermal defect signature. The thermal increase of FIG. 8C occurs earlier in the post-solidification period than the thermal increase of FIG. 7C. The difference between the thermal defect signatures of the subsurface defects of FIGS. 7C and 8C may be due to differences in powder bed material and composition, the location of the subsurface defect, the size of the subsurface defect, and/or the geometry or shape of the subsurface defect. For example, a subsurface defect that is closer to a surface of the powder bed may exhibit a thermal defect signature that occurs earlier in the post-solidification period as compared to a deeper subsurface defect. Additionally, a larger subsurface defect may exhibit a thermal defect signature that is greater in amplitude (e.g., greater increase in post-solidification temperature, greater decrease in cooling rate, etc.) as compared to a smaller subsurface defect.

The post-solidification cooling rate, after the thermal defect signature, in FIGS. 8C and 8D is, on average, roughly the same, which results in both of the thermal histories of FIGS. 8C and 8D having a minimum temperature of between 1500 and 1600 K. Although, the post-solidification cooling curves of FIGS. 8C and 8D exhibit different cooling trends. For example, the post-solidification cooling curve of FIG. 8D is monotonic, while the post-solidification cooling curve of FIG. 8C is not monotonic. As illustrated by FIGS. 7C, 7D, 8C and 8D, various thermal history features such as a post-solidification temperature increase, post-solidification cooling rate, minimum temperature, and post-solidification cooling curve trends may be used to identify profiles for regions of a powder bed having a subsurface defect as described herein. Further, the thermal defect signatures, thermal defect histories, and non-defect thermal histories of FIGS. 7A-7D, and 8A-8D may be determined by methods such as the method 200 of FIG. 2, and subsurface defects may then be determined by detecting the thermal defect signatures as described by the method 300 of FIG. 3. Additionally, As previously mentioned, in embodiments, thermal data taken any time after the maximum temperature has been reached and the powder bed has begun to cool may be used to identify and/or detect a thermal defect signature. Further, as described in reference to the method 400 of FIG. 4, specific characteristics of thermal defect signature (e.g., amount of temperature increase, amount of change of cooling rate, temporal location of defect signature in post-solidification period, etc.) may be used to determine whether a subsurface defect is a critical defect. A user, or processor, may then determine whether a fabrication process should be ended, or if new laser scanning parameters should be determined, and a laser scan performed to remove the subsurface defect.

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

1. A method for performing sub-surface porosity detection in an additively manufactured part, the method comprising: providing, by a laser radiation source, a first radiation to a region of a powder bed along a beam of the first radiation, the region of the powder bed being part of a corresponding region of an additively manufactured part; imaging the region of the powder bed while the first radiation is being provided to the powder bed; generating data sets indicative of the temperature of the region of the powder bed; and detecting, from the data sets, a defect signature indicative of the presence of a sub-surface defect in the region of the additively manufactured part.

2. The method according to aspect 1, wherein imaging the region of the powder bed comprises performing infrared imaging of the region of the powder bed using an infrared camera focused down the beam of the first radiation.

3. The method according to aspect 2, wherein the infrared camera has a pixel size of less than 50 microns.

4. The method according to any of aspects 1 to 3, wherein imaging the region of the powder bed comprises tracking a hot spot region of the powder bed and performing imaging of the hot spot region of the powder bed, wherein the hot spot region is a region of the powder bed having a temperature above a threshold temperature after receiving the first radiation.

5. The method according to aspect 4, wherein the imaging of the hot spot region of the powder bed is performed for 2 milliseconds.

6. The method according to aspect 4, wherein the imaging of the hot spot region of the powder bed is performed for 5 milliseconds.

7. The method according to any of aspects 1 to 6, wherein detecting the defect signature comprises detecting a change in the cooling rate of the region of the additively manufactured part.

8. The method according to aspect 7, wherein detecting the change in the cooling rate of the region comprises detecting a change from a negative slope of the cooling rate to a positive slope of the cooling rate after an absolute maximum temperature has been reached.

9. The method according to aspect 7, wherein detecting the change in the cooling rate of the region comprises detecting a decrease in the absolute value of the cooling rate after an absolute maximum temperature has been reached.

10. The method according to any of aspects 1 to 9, further comprising performing X-ray imaging of the region of the additively manufactured part to detect the presence of the defect after the region of the powder bed has received the first radiation.

11. The method according to aspect 10, further comprising analyzing the X-ray imaging results and the data sets to determine a thermal characteristic of a temperature curve, wherein the thermal characteristic is indicative of the presence of the sub-surface defect.

12. The method according to any of aspects 1 to 11, further comprising providing a second radiation to the region of the additively manufactured part having the sub-surface defect.

13. The method according to aspect 12, wherein the second radiation re-melts the additively manufactured part to release fluids trapped in the additively manufactured part.

14. The method according to aspect 12, wherein the second radiation is provided to the region of the additively manufactured part at a power and for a quantity of time sufficient to release fluids trapped in the additively manufactured part.

15. The method according any of aspects 1 to 14, wherein the imaging is performed with an image resolution of 0.1 milliseconds.

16. An additive manufacturing system comprising: a laser radiation source configured to provide a first radiation to a region of a powder bed along a beam of the first radiation, the region of the powder bed being part of a corresponding region of an additively manufactured part; a thermal sensor focused down the beam of the first radiation configured to image a region of the powder bed; a processor configured to execute machine readable instructions that cause the processor to: obtain, from the thermal sensor, data sets indicative of the temperature of the region of the powder bed; and detect, from the data sets, a defect signature indicative of the presence of a sub-surface defect in the region of the additively manufactured part.

17. The system of aspect 16, wherein the thermal sensor is an infrared camera.

18. The system of aspect 17, wherein the infrared camera has a pixel size of less than 50 microns.

19. The system of any of aspects 16 to 18, wherein the machine readable instructions further cause the processor to determine, from the data sets, a hot spot region of the powder bed, wherein the hot spot region is a region of the powder bed having a temperature above a threshold temperature after receiving the first radiation; and the thermal sensor is further configured to image the hot spot region of the powder bed.

20. The system of aspect 19, wherein the thermal sensor is configured to image the hot spot region of the powder bed for 2 milliseconds.

21. The system of aspect 19, wherein the thermal sensor is configured to image the hot spot region of the powder bed for 5 milliseconds.

22. The system of any of aspects 16 to 21, wherein to detect the defect signature the processor detects a change in the cooling rate of the region of the additively manufactured part.

23. The system of aspect 22, wherein detecting the change in the cooling rate of the region comprises detecting a change from a negative slope of the cooling rate to a positive slope of the cooling rate after an absolute maximum temperature has been reached.

24. The system of aspect 22, wherein detecting the change in the cooling rate of the region comprises detecting a decrease in the absolute value of the cooling rate after an absolute maximum temperature has been reached.

25. The system of any of aspects 16 to 24, further comprising an X-ray imaging system configured to image the region of the additively manufactured part after the region of the powder bed has been provided with the first radiation.

26. The system of aspect 25, wherein the machine readable instructions further cause the processor to analyze the X-ray imaging results and the data sets to determine a thermal characteristic of a temperature curve, wherein the thermal characteristic is indicative of the presence of the sub-surface defect.

27. The system of any of aspects 16 to 26, wherein the machine readable instructions further cause the processor to cause the laser radiation source to provide a second radiation to the region of the additively manufactured part having the sub-surface defect.

28. The system of aspect 27, wherein the second radiation re-melts the additively manufactured part to release fluids trapped in the additively manufactured part

29. The system of aspect 27, wherein the second radiation is provided to the region of the additively manufactured part at a sufficient power and for a sufficient amount of time to release fluids trapped in the additively manufactured part.

30. The system of any of aspects 16 to 29, wherein the thermal sensor has a temporal resolution of 0.1 millisecond.

What is claimed is:

1. A method for performing sub-surface porosity detection in an additively manufactured part, the method comprising:
providing, by a laser radiation source, a first radiation to a region of a powder bed along a beam of the first radiation, the region of the powder bed being part of a corresponding region of an additively manufactured part;
imaging the region of the powder bed while the first radiation is being provided to the powder bed;
generating data sets indicative of the temperature of the region of the powder bed; and
detecting, from the data sets, a defect signature indicative of the presence of a sub-surface defect in the region of the additively manufactured part.

2. The method according to claim 1, wherein imaging the region of the powder bed comprises performing infrared imaging of the region of the powder bed using an infrared camera focused down the beam of the first radiation.

3. The method according to claim 1, wherein imaging the region of the powder bed comprises tracking a hot spot region of the powder bed and performing imaging of the hot spot region of the powder bed, wherein the hot spot region is a region of the powder bed having a temperature above a threshold temperature after receiving the first radiation.

4. The method according to claim 3, wherein the imaging of the hot spot region of the powder bed is performed for between 2 and 5 milliseconds after the threshold temperature has been exceeded.

5. The method according to claim 1, wherein detecting the defect signature comprises detecting a change in the cooling rate of the region of the additively manufactured part.

6. The method according to claim 1, further comprising performing X-ray imaging of the region of the additively manufactured part to detect the presence of the defect after the region of the powder bed has received the first radiation.

7. The method according to claim 6, further comprising analyzing the X-ray imaging results and the data sets to determine a thermal characteristic of a temperature curve, wherein the thermal characteristic is indicative of the presence of the sub-surface defect.

8. The method according to claim 1, further comprising providing a second radiation to the region of the additively manufactured part having the sub-surface defect.

9. The method according to claim 8, wherein the second radiation re-melts the additively manufactured part to release fluids trapped in the additively manufactured part.

10. The method according to claim 1, wherein the imaging is performed with an image resolution of less than 0.2 milliseconds.

11. An additive manufacturing system comprising:
a laser radiation source configured to provide a first radiation to a region of a powder bed along a beam of the first radiation, the region of the powder bed being part of a corresponding region of an additively manufactured part;
a thermal sensor focused down the beam of the first radiation configured to image a region of the powder bed;
a processor configured to execute machine readable instructions that cause the processor to:
obtain from the thermal sensor data sets indicative of the temperature of the region of the powder bed; and
detect, from the data sets, a defect signature indicative of the presence of a sub-surface defect in the region of the additively manufactured part.

12. The system of claim 11, wherein the thermal sensor is an infrared camera.

13. The system of claim 11, wherein the machine readable instructions further cause the processor to determine, from the data sets, a hot spot region of the powder bed, wherein the hot spot region is a region of the powder bed having a temperature above a threshold temperature after receiving the first radiation; and
the thermal sensor is further configured to image the hot spot region of the powder bed.

14. The system of claim 13, wherein the thermal sensor is configured to image the hot spot region of the powder bed for between 2 and 5 milliseconds after the threshold temperature has been exceeded.

15. The system of claim 11, wherein to detect the defect signature the processor detects a change in the cooling rate of the region of the additively manufactured part.

16. The system of claim 11, further comprising an X-ray imaging system configured to image the region of the additively manufactured part after the region of the powder bed has been provided with the first radiation.

17. The system of claim 16, wherein the machine readable instructions further cause the processor to analyze the X-ray imaging results and the data sets to determine a thermal characteristic of a temperature curve, wherein the thermal characteristic is indicative of the presence of the sub-surface defect.

18. The system of claim 11, wherein the machine readable instructions further cause the processor to cause the laser radiation source to provide a second radiation to the region of the additively manufactured part having the sub-surface defect.

19. The system of claim 18, wherein the second radiation re-melts the additively manufactured part to release fluids trapped in the additively manufactured part

20. The system of claim 11, wherein the thermal sensor has a temporal resolution of less than 0.2 milliseconds.
